(19) United States
(12) Patent Application Publication
(10) Pub. No.: US 2026/0353316 A1
(43) Pub. Date: Nov. 5, 2026

(54) AMBIENT POWER SYNCHRONIZATION FIELD DESIGN

(71) Applicant: QUALCOMM Incorporated, San Diego, CA (US)

(72) Inventors: Stephen Jay SHELLHAMMER, Ramona, CA (US); Bin TIAN, San Diego, CA (US); Jialing Li CHEN, San Diego, CA (US); Pooria PAKROOH, San Diego, CA (US); Manideep DUNNA, San Jose, CA (US)

(21) Appl. No.: 19/638,938

(22) Filed: Apr. 3, 2026

Related U.S. Application Data
(60) Provisional application No. 63/798,478, filed on May 1, 2025.

(51) Int. Cl. H04W 56/00

(52) U.S. Cl. CPC H04W 56/001

(57) ABSTRACT

This disclosure provides methods, components, devices and systems for a synchronization field design for downlink communication of a physical layer protocol data unit (PPDU). In some examples, a station (STA) may receive a PPDU including a synchronization field and a data field. The synchronization field may include a first portion that is Manchester encoded and a second portion that includes a sequence of on symbols and off symbols that is invalid when using Manchester encoding. In some examples, the STA may identify an end of the synchronization field according to detecting the second portion, and may decode the first portion using a Manchester decoding algorithm. The STA may synchronize parameters based on the synchronization field and decode the data field of the PPDU based on the parameters.

### CROSS REFERENCE

This present Application for Patent claims benefit of U.S. Provisional Patent Application No. 63/798,478 by SHELLHAMMER et al., entitled “AMBIENT POWER SYNCHRONIZATION FIELD DESIGN,” filed May 1, 2025, which is assigned to the assignee hereof, and expressly incorporated herein

### TECHNICAL FIELD

This disclosure relates generally to wireless communication and, more specifically, to ambient power synchronization field design.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure may be implemented in a method for wireless communication by an apparatus. The method may include generating a physical layer protocol data unit (PPDU) including a synchronization field and a data field, the synchronization field including a first portion that is Manchester encoded and a second portion that includes a sequence of on symbols and off symbols that is invalid when using Manchester encoding and transmitting the PPDU.

Another innovative aspect of the subject matter described in this disclosure may be implemented in an apparatus for wireless communications. The apparatus may include a processing system that includes processor circuitry and memory circuitry that stores code. The processing system may be configured to cause the apparatus to generate a PPDU including a synchronization field and a data field, the synchronization field including a first portion that is Manchester encoded and a second portion that includes a sequence of on symbols and off symbols that is invalid when using Manchester encoding and transmit the PPDU.

Another innovative aspect of the subject matter described in this disclosure may be implemented in an apparatus for wireless communication. The apparatus may include means for generating a PPDU including a synchronization field and a data field, the synchronization field including a first portion that is Manchester encoded and a second portion that includes a sequence of on symbols and off symbols that is invalid when using Manchester encoding and means for transmitting the PPDU.

Another innovative aspect of the subject matter described in this disclosure may be implemented in a non-transitory computer-readable medium storing code for wireless communication. The code may include instructions executable by one or more processors to generate a PPDU including a synchronization field and a data field, the synchronization field including a first portion that is Manchester encoded and a second portion that includes a sequence of on symbols and off symbols that is invalid when using Manchester encoding and transmit the PPDU.

In some examples of the method, apparatuses, and non-transitory computer-readable medium described herein, the second portion may be indicative of an end of the synchronization field.

In some examples of the method, apparatuses, and non-transitory computer-readable medium described herein, the second portion includes at least three consecutive on symbols or at least three consecutive off symbols.

In some examples of the method, apparatuses, and non-transitory computer-readable medium described herein, the first portion of the synchronization field may be a Manchester encoded version of a second sequence of bits.

In some examples of the method, apparatuses, and non-transitory computer-readable medium described herein, the second sequence includes an equal number (e.g., quantity) of ones and zeros.

Another innovative aspect of the subject matter described in this disclosure may be implemented in a method for wireless communication by an apparatus. The method may include receiving a PPDU including a synchronization field and a data field, the synchronization field including a first portion that is Manchester encoded and a second portion that includes a sequence of on symbols and off symbols that is invalid when using Manchester encoding, decoding the first portion of the sequence via a Manchester decoding algorithm, and synchronizing one or more parameters based on decoding the first portion of the synchronization field.

Another innovative aspect of the subject matter described in this disclosure may be implemented in an apparatus for wireless communication. The apparatus may include a processing system that includes processor circuitry and memory circuitry that stores code. The processing system may be configured to cause the apparatus to receive a PPDU including a synchronization field and a data field, the synchronization field including a first portion that is Manchester encoded and a second portion that includes a sequence of on symbols and off symbols that is invalid when using Manchester encoding, decode the first portion of the sequence via a Manchester decoding algorithm, and synchronize one or more parameters based on decoding the first portion of the synchronization field.

Another innovative aspect of the subject matter described in this disclosure may be implemented in an apparatus for wireless communication. The apparatus may include means for receiving a PPDU including a synchronization field and a data field, the synchronization field including a first portion that is Manchester encoded and a second portion that includes a sequence of on symbols and off symbols that is invalid when using Manchester encoding, means for decoding the first portion of the sequence via a Manchester decoding algorithm, and means for synchronizing one or more parameters based on decoding the first portion of the synchronization field.

Another innovative aspect of the subject matter described in this disclosure may be implemented in a non-transitory computer-readable medium storing code for wireless communication. The code may include instructions executable by one or more processors to receive a PPDU including a synchronization field and a data field, the synchronization field including a first portion that is Manchester encoded and a second portion that includes a sequence of on symbols and off symbols that is invalid when using Manchester encoding, decode the first portion of the sequence via a Manchester decoding algorithm, and synchronize one or more parameters based on decoding the first portion of the synchronization field.

In some examples of the method, apparatuses, and non-transitory computer-readable medium described herein, the second portion may be indicative of an end of the synchronization field.

In some examples of the method, apparatuses, and non-transitory computer-readable medium described herein, the second portion includes at least three consecutive on symbols or at least three consecutive off symbols.

In some examples of the method, apparatuses, and non-transitory computer-readable medium described herein, the first portion of the synchronization field may be a Manchester encoded version of a second sequence of bits.

In some examples of the method, apparatuses, and non-transitory computer-readable medium described herein, the second sequence includes an equal number (e.g., quantity) of ones and zeros.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a frequency diagram depicting an example distributed tone mapping.

FIG. 5 shows a pictorial diagram of another example wireless communication network.

FIG. 6 shows an example of an ambient power PPDU that supports ambient power synchronization field design.

FIG. 7 shows an example of a process flow that supports ambient power synchronization field design.

FIG. 8 shows a block diagram of an example wireless communication device that supports ambient power synchronization field design.

FIG. 9 shows a block diagram of an example wireless communication device that supports ambient power synchronization field design.

FIGS. 10 and 11 show flowcharts illustrating example processes performable by or at a STA that supports ambient power synchronization field design.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein may be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples may be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device (such as, a station (STA)) that is receiving signals may be a low power device. Examples of the low power device may include a backscatter device or a non-backscatter device. In some examples, the low power device may be referred to as an ambient power (AMP) device. Some low power devices may support transmission and/or reception (such as reception by a STA) using on-off keying (OOK) waveforms. The AP and the lower power devices may communicate physical layer protocol data units (PPDUs) at different data rates (for example, up to 250 kilobit per second (kb/s), up to 1 Megabit per second (Mb/s), or up to 4 Mb/s). In some implementations, the PPDU may include a synchronization (SYNC) field prior to a data field. The SYNC field may be used for packet detection, timing estimate and correction, identifying the beginning of the data field, and automatic gain control (AGC). The low power devices may detect the SYNC field in downlink communications to facilitate communications at different data rates.

Various aspects relate generally to the SYNC field. Some aspects more specifically relate to a SYNC field design for downlink communication of a PPDU. In some examples, the STA may obtain a PPDU comprising a SYNC field and a data field. The SYNC field may be configured to facilitate communications at different data rates and for different ways to detect SYNC fields. The SYNC field may include a first portion with a sequence of symbols (such as on symbols and off symbols) that are Manchester encoded and a second portion with a sequence of symbols (such as on symbols and off symbols) that is invalid when using Manchester encoding. In some implementations, the first portion of the SYNC field may be a Manchester encoded version of a second sequence of bits (such as a sequence B) and the second portion may indicate an end of the SYNC field. In some examples, the second portion may support the receiving wireless communication device (such as a STA) differentiating between the SYNC field and the data field of the PPDU, between the second portion and the first portion, or between the PPDU (such as the data field of the PPDU) and another transmission (such as another transmission from another device). For example, the receiving wireless communication device (such as a STA) may account for reception timing errors by identifying the second portion. In some implementations, the SYNC field may support detection by various types of detectors, such as a correlation detector, a bit-by-bit detector (such as by relatively simple comparison circuitry), or both.

Particular aspects of the subject matter described in this disclosure may be implemented to realize one or more of the following potential advantages. In some examples, by designing the SYNC field to include a first portion with a Manchester encoded version of a sequence of bits, the described techniques may be used to improve detection of the SYNC field by low power devices. In some implementations, by designing the SYNC field to include a second portion that is invalid when using Manchester encoding, the described techniques may be used to mitigate errors related to timing misalignment when detecting the SYNC field by low power devices. In some examples, by configuring the sequence of bits encoded in the SYNC field to support correlation detection, the described techniques may be used for detection of the SYNC field by low power devices according to various detection mechanisms with different levels of complexity.

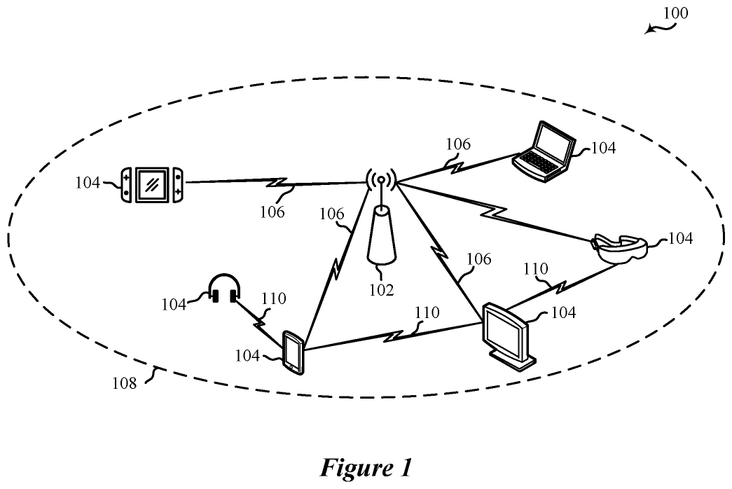

FIG. 1 shows a pictorial diagram of an example wireless communication network 100. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 may be an example of a cellular radio access network (RAN), such as a 5G or 6G RAN that implements one or more cellular protocols such as those specified in one or more 3GPP standards. In some other examples, the wireless communication network 100 may include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 may include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number (e.g., quantity) of wireless stations (STAs) 104. While only one AP 102 is shown in FIG. 1, the wireless communication network 100 may include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 may be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast (e.g., broadcast in accordance with a periodicity) beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons may include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 may be covered by more than one AP 102 and may associate with different APs 102 at different times for different transmissions. Additionally, after association with an AP 102, a STA 104 also may periodically scan (e.g., scan in accordance with a periodicity) its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also may communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices may occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels may be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment may be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

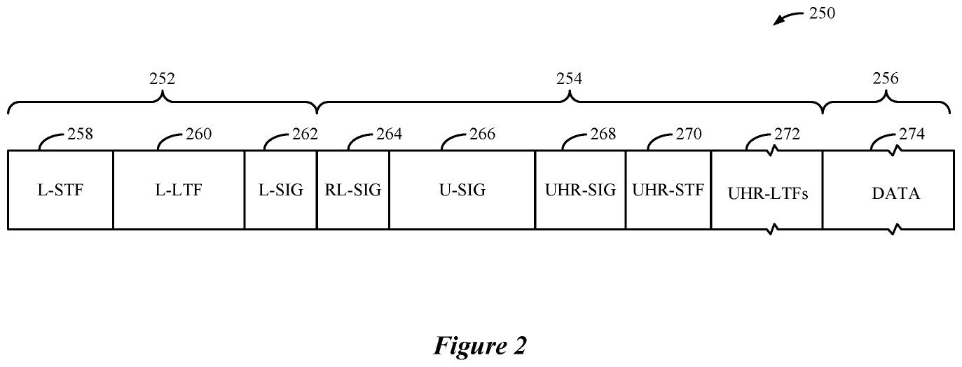

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (such as STA-specific) signaling information. Each UHR-SIG 268 may include a common field and at least one user-specific field. In the context of OFDMA, the common field may indicate RU distributions to multiple STAs 104, indicate the RU assignments in the frequency domain, indicate which RUs are allocated for MU-MIMO transmissions and which RUs correspond to OFDMA transmissions, and the number (e.g., quantity) of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format may enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (such as a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (such as a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

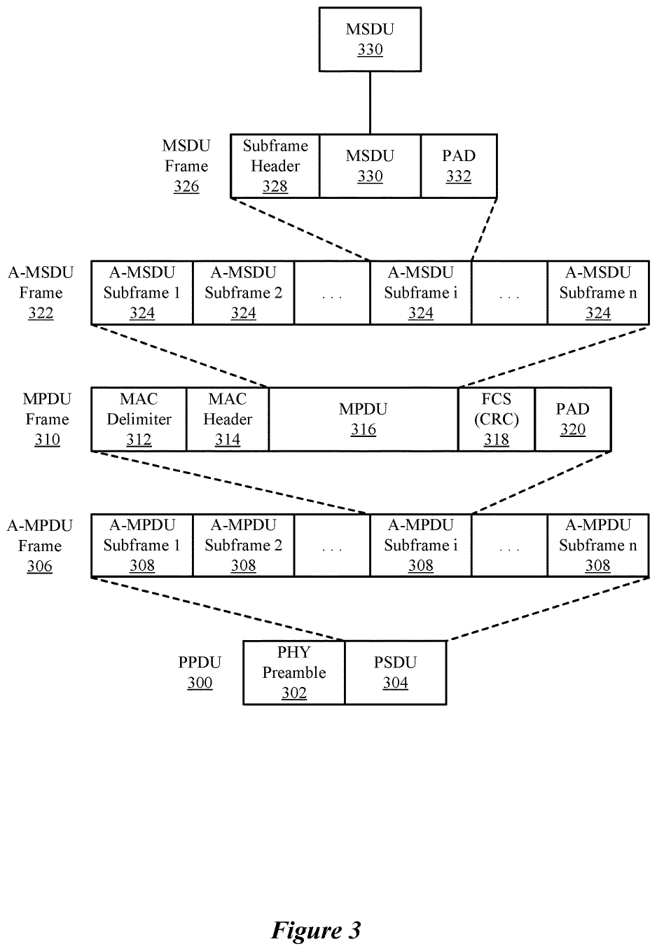

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 may be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits may undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be multiplied by the number (e.g., quantity) of copies of the data being transmitted, at the expense of utilizing an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number (e.g., quantity) of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

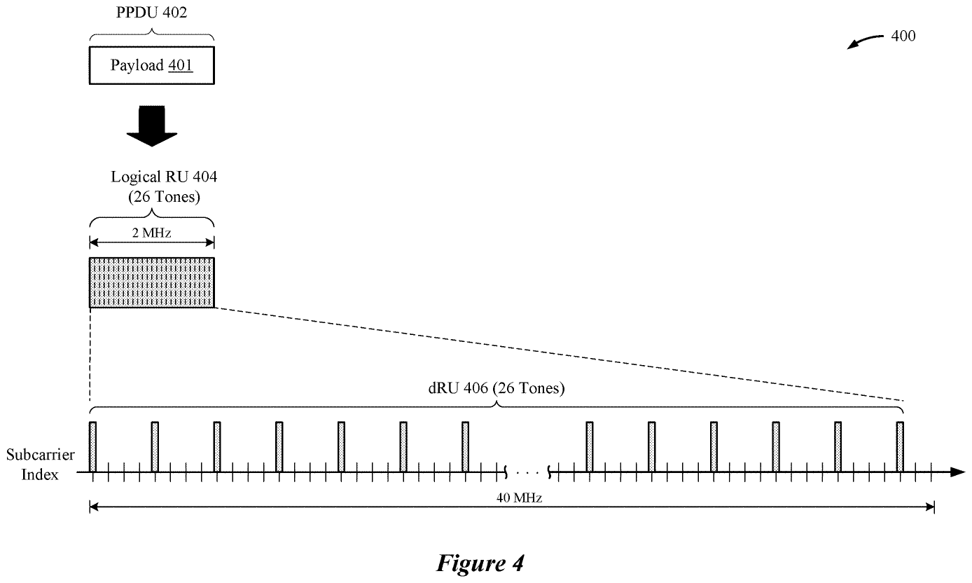

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number (e.g., quantity) of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number (e.g., quantity) of tones (of the logical RU 404) in each 1 MHz subchannel. For example, each of the 26 tones may be mapped to a different 1 MHz subchannel of the 40 MHz channel. As a result, each AP 102 or STA 104 implementing the distributed tone mapping of FIG. 4 may maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power may be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which may be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 may recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 may be mapped to any suitable pattern of noncontiguous subcarrier indices. For example, in various implementations, the distance between any pair of adjacent modulated tones may be less than or greater than the distances depicted in FIG. 4.

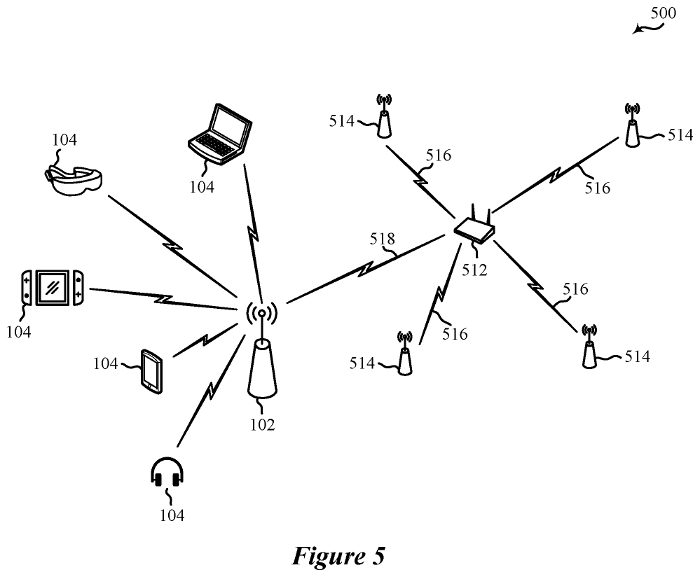

FIG. 5 shows a pictorial diagram of another example wireless communication network 500. According to some aspects, the wireless communication network 500 may be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 may communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 may analyze, preprocess and aggregate data received from the wireless communication devices 514 locally at the edge before transmitting it to other devices or external networks via the Wi-Fi link 518. The intermediate device 512 also may provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

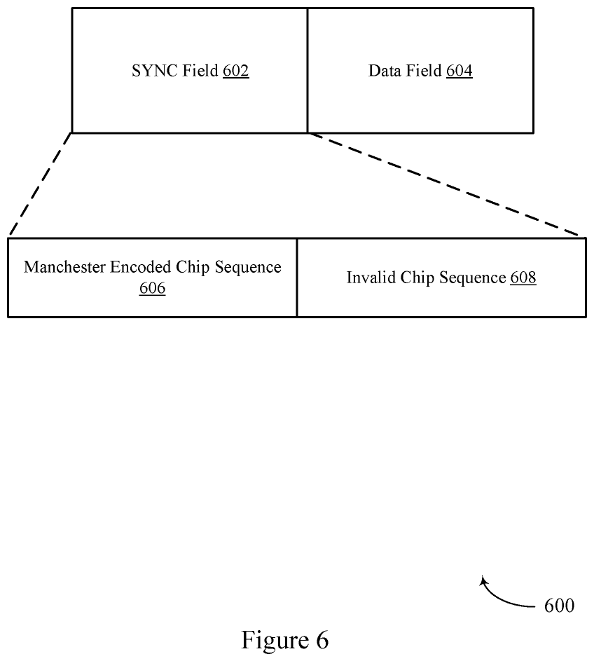

FIG. 6 shows an example of a PPDU 600 that supports ambient power synchronization field design. The PPDU 600 may implement, or be implemented by, one or more aspects of FIGS. 1-5. For example, a receiving device, such as a STA, may receive the PPDU 600 from a transmitting device, such as an AP, which may be examples of corresponding devices described with reference to FIGS. 1-5. In some examples, the receiving device may be an example of a STA, a low power device, an ultra-low power device, a backscatter device, a non-backscatter device, or a tag.

Some wireless communication systems may support low power or ultra-low power devices, which may be battery-less devices. Low power devices may include non-backscatter devices (such as a micro-power STA, an active transmission STA, or an AMP assisted STAs) and backscatter devices (such as a close-range monostatic backscatter device, or a bi-static backscatter device). A backscatter device may refer to a type of communication technology that enables wireless communication by reflecting existing communication signals, rather than generating new ones. Backscatter devices leverage ambient signals to transmit data, which may significantly reduce power consumption compared to non-backscatter communication techniques. The backscatter device may be an example of a passive or semi-passive device, and the backscatter device may communicate with another wireless communication device (such as an AP or a reader device) via backscatter. For example, the backscatter device may receive a waveform from the AP or reader device, which may activate the backscatter device, and the backscatter device may communicate by modulating a reflection of the received waveform rather than transmitting its own signal. Examples of backscatter devices may include various forms for RFID tags or other tags. The non-backscatter device, active transmission device, or AMP assisted STA may generate its own RF signals to transmit data. The non-backscatter device may have a power source, such as a battery, to generate the RF signals. Another type of non-backscatter device may not have a battery, and the device may harvest energy (such as RF energy) and may store the harvested energy on a capacitor. The backscatter device may not have a power source, and the backscatter device may derive energy from the incident RF signal. Another type of AMP device may be a non-AP STA referred to as an AMP assisted STA. The active transmission device and the AMP assisted STA may be referred to as non-backscatter devices.

Some non-backscatter devices and backscatter devices may support receiving the PPDU 600. For example, a receiving device may receive, via downlink communications, the PPDU 600 including a SYNC field 602 and a data field 604. In some examples, the SYNC field 602 may be prior to the data field 604. The receiving device may use the SYNC field 602 to synchronize one or more parameters prior to decoding the data field 604. For example, the receiving device may use the SYNC field 602 for one or more of packet detection, timing estimation and correction, identifying a beginning of a possible SIG field (if present), identifying a beginning of the data field 604, or automatic gain control (ACG).

The SYNC field 602 may be designed for downlink communications with low complexity for detection by the non-backscatter devices and the backscatter devices. The SYNC field 602 may include a sequence of symbols that may be detected by the non-backscatter device and the backscatter device. In some implementations, the SYNC field 602 may include multiple portions. For example, the SYNC field 602 may include a first portion that is a Manchester encoded chip sequence 606 and a second portion that is an invalid chip sequence 608 (such as a sequence that is invalid when using Manchester encoding). Alternatively, the first portion of the SYNC field 602 may not be Manchester encoded, and may include a sequence of symbols (such as a sequence of values that are not Manchester encoded).

The Manchester encoded chip sequence 606 (such as a chip sequence W) may be a sequence of ON symbols and OFF symbols encoded from a sequence of bits (such as a sequence of bits B). According to the Manchester encoding, each bit of the sequence of bits may be encoded according to a value of the bit. For example, a low bit (such as a bit having a value ‘0’) of the sequence of bits may be encoded according to a first Manchester encoded chip sequence (such as a sequence with an ON symbol followed by an OFF symbol, for example ‘10’), and a high bit (such as a bit having a value ‘1’) of the sequence of bits may be encoded according to a second Manchester encoded chip sequence (such as a sequence with an OFF symbol followed by an ON symbol, for example ‘01’).

Some receiving devices may detect the SYNC field 602 using a correlation detector, which may include relatively complex or high-power circuitry and components. For example, the correlation detector may include one or more of an analog-to-digital (ADC) sampler, a shift register, or digital circuitry to process shift register data (such as a reference array and a summing component). In some implementations, encoding the first portion of the SYNC field 602 (such as the Manchester encoded chip sequence 606) may support detection of the SYNC field 602 by low power devices with relatively low complexity. For example, the receiving device may detect the SYNC field 602 according to bit-by-bit detection, which may refer to a relatively low-complexity detection mechanism (such as by keeping detection within an analog domain).

Detecting the SYNC field 602 using a bit-by-bit detector may include the receiving device storing energy in capacitors and comparing the stored energy of the capacitors to decode a bit of a bit sequence. For example, the receiving device may receive a first symbol and a second symbol (which may be referred to a chips) as part of the Manchester encoded chip sequence 606, and may store energy from the first symbol in a first capacitor and may store energy from the second symbol in a second capacitor. The receiving device may compare the stored energy of the capacitors to decode a bit according to Manchester decoding. As an example, if the first capacitor stores more energy than the second capacitor, the receiving device may decode a low bit (such as decoding a ‘0’ if consecutive symbols of the Manchester encoded chip sequence 606 are ‘10’) and, if the first capacitor stores less energy than the second capacitor, the receiving device may decode a high bit (such as decoding a ‘1’ if consecutive symbols of the Manchester encoded chip sequence 606 are ‘10’). In some examples, the Manchester encoding may result in the Manchester encoded chip sequence 606 including a quantity of symbols (chips) that is double a quantity of bits in the bit sequence (each bit may be represented by two chips in the Manchester encoded chip sequence 606).

The SYNC field 602 may further include an invalid chip sequence 608. The invalid chip sequence 608 may include a sequence of symbols (such as chips) that cannot be generated by Manchester encoding. For example, the invalid chip sequence 608 may include three or more consecutive on symbols (such as 111) or three or more consecutive off symbols (such as 000). The invalid chip sequence 608 may be longer than three symbols and may include any pattern of symbols to distinguish it from other parts of the PPDU. The invalid chip sequence 608 may be referred to as an invalid field or mark field. The invalid chip sequence 608 may support the receiving device distinguishing the Manchester encoded chip sequence 606 from the invalid chip sequence 608, the SYNC field 602 from the data field 604, and the PPDU 600 from other transmissions from other wireless communication devices (such as PPDUs communicated by the same or different transmitting devices). In some examples, the invalid chip sequence 608 may support the receiving device identifying an end of the SYNC field 602 and may support the receiving device detecting timing misalignment for reception of the PPDU 600.

In some examples, a transmitting device may configure or select the sequence of bits (B) and the Manchester encoded chip sequence 606 (W) to support detection by either of a correlation detector and a bit-by-bit detector. For example, the Manchester encoding may prevent timing errors when the receiving device receives the SYNC field 602 (such as avoiding a false shift error), such as the receiving device failing to identify a sequence of low bits when noise is present (the Manchester encoding may ensure diversity between high and low signals received at the receiving device). In some implementations, the transmitted device may configure or select the sequence of bits such that the Manchester encoded chip sequence 606 starts with an OFF symbol. For example, a preamble of the PPDU 600 may include a relatively high number (e.g., quantity) of ON symbols, such that the Manchester encoded chip sequence 606 including a first symbol that is an OFF symbol may support the receiving device identifying the beginning of the SYNC field 602.

In some implementations, the transmitting device may configure or select the sequence of bits to have a property of good autocorrelation (such as having small peaks other than a main peak in the autocorrelation function), even if the receiving device does not use a correlator for SYNC field 602 detection. Having good autocorrelation properties may prevent the sequence of bits from having matching portions after a time offset (such as repeated sub-sequences that may be confused for one another). The transmitting device may configure or select the sequence of bits to include an equal number (e.g., quantity) of high bits (such as 1s) and low bits (such as 0s), which may support good autocorrelation. In some examples, configuring or selecting the sequence of bits to have good autocorrelation properties may result in the Manchester encoded chip sequence 606 having good autocorrelation properties (B may be selected so that W has good autocorrelation properties and supports a bit-by-bit detector and a correlation detector). The sequence of bits may define the Manchester encoded chip sequence 606 (W) and a logical complement of W (W̅) (such as W̅=1~W). In some examples, the transmitting device may configure or select the sequence of bits such that W has good autocorrelation properties.

The sequence of bits may include one or more quantity of bits. For example, the sequence of bits may include 10 bits. Table 1 illustrates candidate B values and corresponding W values when the sequence of bits includes 10 bits.

TABLE 1

| Bit Sequence | Chip Sequence |
|---|---|
| 0010101110 | 10100110011001010110 |
| 0100101110 | 10011010011001010110 |
| 0111010010 | 10010101100110100110 |
| 0111010100 | 10010101100110011010 |
| 1000101011 | 01101010011001100101 |
| 1000101101 | 01101010011001011001 |
| 1011010001 | 01100101100110101001 |
| 1101010001 | 01011001100110101001 |

As another example, the sequence of bits may include 12 bits. Table 2 illustrates candidate B values and corresponding W values when the sequence of bits includes 12 bits.

TABLE 2

| Bit Sequence | Chip Sequence |
|---|---|
| 100011011010 | 011010100101100101100110 |
| 101001001110 | 011001101001101001010110 |
| 101011011000 | 011001100101100101101010 |
| 101011100100 | 011001100101011010011010 |
| 110110001010 | 010110010110101001100110 |
| 110110101000 | 010110010110011001101010 |
| 111001001010 | 010101101001101001100110 |
| 111010100100 | 010101100110011010011010 |

As another example, the sequence of bits may include 14 bits. Table 3 illustrates candidate B values and corresponding W values when the sequence of bits includes 14 bits.

TABLE 3

| Bit Sequence | Chip Sequence |
|---|---|
| 00011011010101 | 1010100101100101100110011001 |
| 00100110101011 | 1010011010010110011001100101 |
| 00101001011101 | 1010011001101001100101011001 |
| 00101010011011 | 1010011001100110100101100101 |
| 01000101101011 | 1001101010011001011001100101 |
| 01010100100111 | 1001100110011010011010010101 |
| 10001010110110 | 0110101001100110010110010110 |
| 10001101101010 | 0110101001011001011001100110 |
| 10010010101110 | 0110100110100110011001010110 |
| 10010011101010 | 0110100110100101011001100110 |
| 10101000110110 | 0110011001101010010110010110 |
| 10101001001110 | 0110011001101001101001010110 |
| 10101011011000 | 0110011001100101100101101010 |
| 10101101100010 | 0110011001011001011010100110 |
| 10101110010010 | 0110011001010110100110100110 |
| 10110110001010 | 0110010110010110101001100110 |
| 10111001001010 | 0110010101101001101001100110 |
| 10111010010100 | 0110010101100110100110011010 |
| 10111010100100 | 0110010101100110011010011010 |
| 11010110100010 | 0101100110010110011010100110 |
| 11011010100010 | 0101100101100110011010100110 |
| 11100100101010 | 0101011010011010011001100110 |

As another example, the sequence of bits may include 16 bits. Table 4 illustrates candidate B values and corresponding W values when the sequence of bits includes 16 bits.

TABLE 4

| Bit Sequence | Chip Sequence |
|---|---|
| 0010100110111010 | 10100110011010010110010101100110 |
| 0010110011101010 | 10100110010110100101011001100110 |
| 0101010010011110 | 10011001100110100110100101010110 |
| 0111100100101010 | 10010101011010011010011001100110 |
| 1000011011010101 | 01101010100101100101100110011001 |
| 1010001001101011 | 01100110101001101001011001100101 |
| 1010100011001011 | 01100110011010100101101001100101 |
| 1010101101100001 | 01100110011001011001011010101001 |

In some examples, by designing the SYNC field 602 to include the Manchester encoded chip sequence 606 (such as a Manchester encoded version of a sequence of bits), the described techniques may be used to improve detection of the SYNC field 602 by low power devices. In some implementations, by designing the SYNC field 602 to include the invalid chip sequence 608 (such as a sequence of ON symbols and OFF symbols that is invalid when using Manchester encoding), the described techniques may be used to mitigate errors related to timing misalignment when detecting the SYNC field 602 by low power devices. In some examples, by configuring the sequence of bits encoded in the SYNC field 602 to support correlation detection, the described techniques may be used for detection of the SYNC field by low power devices according to various detection mechanisms with different levels of complexity (such as correlation detection and bit-by-bit detection).

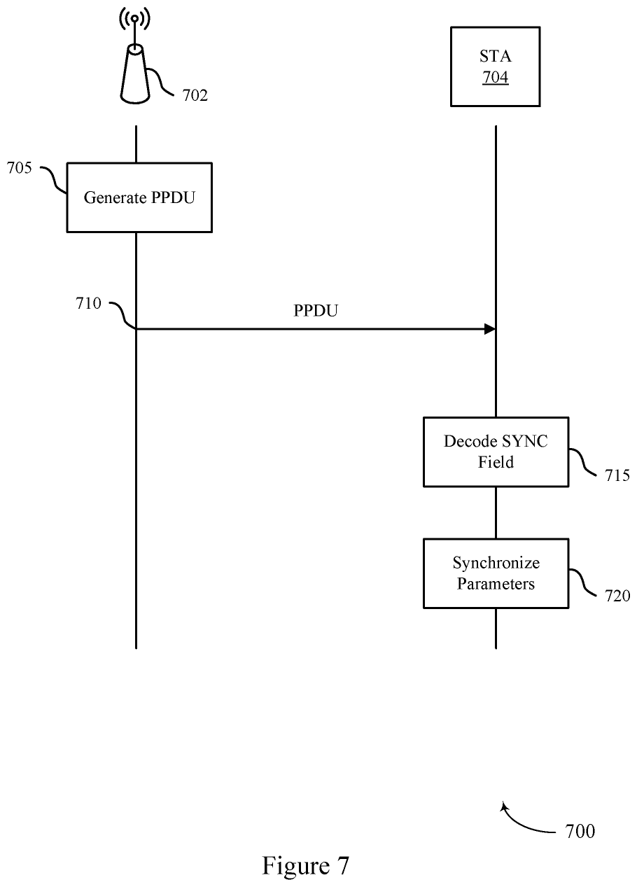

FIG. 7 shows an example of a process flow 700 that supports ambient power synchronization field design. The process flow 700 may implement, or be implemented by, one or more aspects of FIGS. 1-6. For example, the process flow 700 illustrates signaling between and operations by an AP 702 and a STA 704, which may be examples of corresponding devices described with reference to FIGS. 1-6. In some examples, the process flow 700 may support communicating an AMP PPDU including a SYNC field and a data field, where the SYNC field may include a first portion that is Manchester encoded and a second portion that is invalid when using Manchester encoding, which may support a low power device (such as the STA 704) detecting the SYNC field. Alternative examples of the following may be implemented, where some processes are performed in a different order than described or are not performed. In some examples, processes may include additional features not mentioned below, or further processes may be added.

At 705, the AP 702 may generate a PPDU. For example, the AP 702 may generate an AMP PPDU. The AMP PPDU may include a SYNC field and a data field. The SYNC field may include a first portion that is Manchester encoded and a second portion that includes a sequence of on symbols and off symbols, where the sequence may be invalid when using Manchester encoding. The Manchester encoding may include encoding a sequence of bits (which may be referred to as a second sequence of bits) such that each bit of the sequence of bits is represented by a sequence of chips according to the Manchester encoding. For example, a high bit (such as a binary ‘1’) may be encoded as a first sequence of chips (such as a sequence ‘01’) and a low bit (such as a binary ‘0’) may be encoded as a second sequence of chips (such as a sequence ‘10’).

The AP 702 may encode the sequence of bits to generate the first portion of the SYNC field, where the first portion may include a quantity of symbols that is double a quantity of bits in the sequence of bits. In some examples, the sequence of bits may include 10 bits, 12 bits, 14 bits, or 16 bits. In some examples, the sequence of bits may include an equal number (e.g., quantity) of ones and zeros. In some examples, the AP 702 may select a sequence of bits for Manchester encoding such that a first symbols of the first portion of the SYNC field is an off symbol (which may support differentiating from a preamble of the PPDU, which may be generally high bits). The second portion may be indicative of an end of the SYNC field. For example, the AP 702 may include at least three consecutive on symbols or at least three consecutive off symbols in the second portion (such as a sequence that cannot be obtained when using Manchester encoding). In some examples, the AP 702 may select the sequence of bits to support good autocorrelation properties for the sequence of bits, the Manchester encoded symbols, and a logical complement of the Manchester encoded symbols.

At 710, the AP 702 may transmit the PPDU to the STA 704. For example, the STA 704 may receive the AMP PPDU that includes the SYNC field and the data field, where the SYNC field may include the first portion that is Manchester encoded and the second portion that includes a sequence of on symbols and off symbols that is invalid when using Manchester encoding. In some examples, the second portion may support the STA 704 differentiating the SYNC field from the data field, the first portion of the SYNC field from the second portion of the SYNC field, and the AMP PPDU from other transmissions from other wireless communication devices.

At 715, the STA 704 may decode the SYNC field. For example, the STA 704 may decode the first portion of the synchronization field via a Manchester decoding algorithm (such as to obtain the sequence of bits). In some examples, the STA 704 may determine that the SYNC field has ended based on detecting the second portion of the SYNC field that includes a sequence of on symbols and off symbols that is invalid when using Manchester encoding.

At 720, the STA 704 may synchronize one or more parameters based on decoding the SYNC field. For example, the one or more parameters synchronized by the synchronization field may include one or more timing parameters, one or more frequency parameters, estimating channel characteristics, detecting one or more frames, or any combination thereof. In some examples, the synchronization field may allow the STA 704 to synchronize its timing with the incoming signal. Timing synchronization helps ensure that the STA 704 may correctly interpret the start and end of each bit in the data stream. In some examples, the synchronization field helps the STA 704 to adjust a local oscillator to match the frequency of the incoming signal. This may enable the STA 704 to compensate for any frequency offset between the AP 702 and STA 704, which may occur due to differences in their respective clocks. In some examples, the synchronization field provides information that the STA 704 may use to estimate the characteristics of the communication channel, such as signal strength and multipath effects. This may improve the decoding process and the overall reliability of the communication. In some examples, the synchronization field may help the STA 704 to detect the presence of a frame. For instance, the synchronization field may indicate that a valid frame is about to be received, allowing the STA 704 to prepare for processing the subsequent data in the data field.

In some examples, by designing the SYNC field to include the Manchester encoded chip sequence (such as a Manchester encoded version of a sequence of bits), the described techniques may be used to improve detection of the SYNC field by low power devices. In some implementations, by designing the SYNC field to include the invalid chip sequence (such as a sequence of ON symbols and OFF symbols that is invalid when using Manchester encoding), the described techniques may be used to mitigate errors related to timing misalignment when detecting the SYNC field by low power devices. In some examples, by configuring the sequence of bits encoded in the SYNC field to support correlation detection, the described techniques may be used for detection of the SYNC field by low power devices according to various detection mechanisms with different levels of complexity (such as correlation detection and bit-by-bit detection).

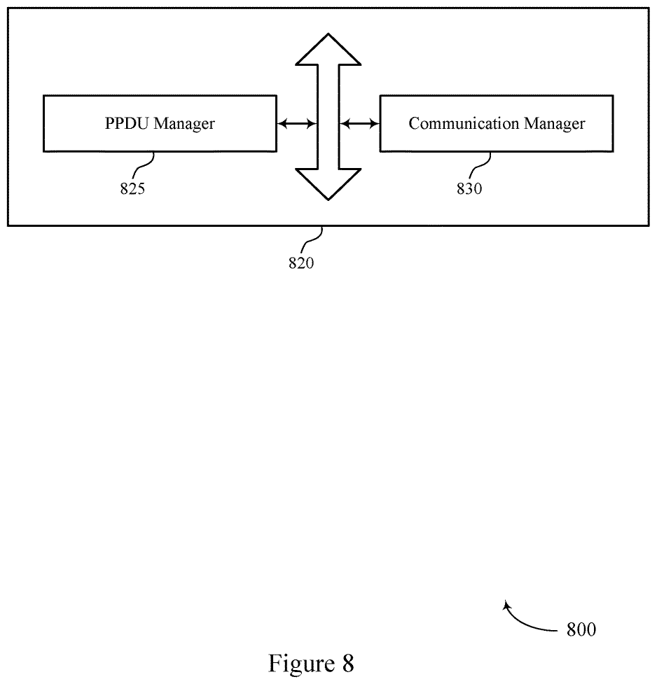

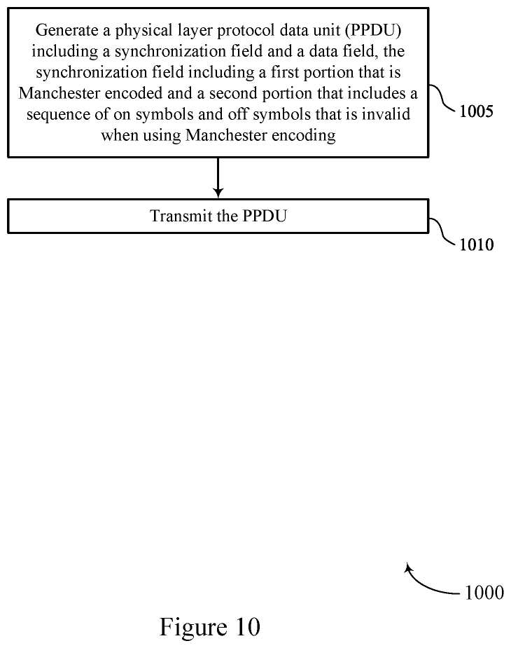

FIG. 8 shows a block diagram 800 of an example wireless communication device 820 that supports ambient power synchronization field design. In some examples, the wireless communication device 820 is configured to perform the process 1000 described with reference to FIG. 10. The wireless communication device 820 may include one or more chips, SoCs, chipsets, packages, components or devices that individually or collectively constitute or include a processing system. The processing system may interface with other components of the wireless communication device 820, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 820 may transmit the information output from the chip. In such an example, the second interface may refer to an interface between the processing system of the chip and a reception component, such that the wireless communication device 820 may receive information that is then passed to the processing system. In some such examples, the first interface also may obtain information, such as from the transmission component, and the second interface also may output information, such as to the reception component.

The processing system of the wireless communication device 820 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 820 may be configurable or configured for use in an AP, such as the AP 102 described with reference to FIG. 1. In some other examples, the wireless communication device 820 may be an AP that includes such a processing system and other components including multiple antennas. The wireless communication device 820 is capable of transmitting and receiving wireless communications in the form of, for example, wireless packets. For example, the wireless communication device 820 may be configurable or configured to transmit and receive packets in the form of physical layer PPDUs and MPDUs conforming to one or more of the IEEE 802.11 family of wireless communication protocol standards. In some other examples, the wireless communication device 820 may be configurable or configured to transmit and receive signals and communications conforming to one or more 3GPP specifications including those for 5G NR or 6G. In some examples, the wireless communication device 820 also includes or may be coupled with one or more application processors which may be further coupled with one or more other memories. In some examples, the wireless communication device 820 further includes at least one external network interface coupled with the processing system that enables communication with a core network or backhaul network that enables the wireless communication device 820 to gain access to external networks including the Internet.

The wireless communication device 820 includes a PPDU manager 825 and a communication manager 830. Portions of one or more of the PPDU manager 825 and the communication manager 830 may be implemented at least in part in hardware or firmware. For example, one or more of the PPDU manager 825 and the communication manager 830 may be implemented at least in part by at least a processor or a modem. In some examples, portions of one or more of the PPDU manager 825 and the communication manager 830 may be implemented at least in part by a processor and software in the form of processor-executable code stored in memory.

The wireless communication device 820 may support wireless communication in accordance with examples as disclosed herein. The PPDU manager 825 is configurable or configured to generate a physical layer protocol data unit (PPDU) including a synchronization field and a data field, the synchronization field including a first portion that is Manchester encoded and a second portion that includes a sequence of on symbols and off symbols that is invalid when using Manchester encoding. The communication manager 830 is configurable or configured to transmit the PPDU.

In some examples, the second portion is indicative of an end of the synchronization field.

In some examples, the second portion includes at least three consecutive on symbols or at least three consecutive off symbols.

In some examples, a first symbol of the first portion of the synchronization field includes an off symbol.

In some examples, the first portion of the synchronization field is a Manchester encoded version of a second sequence of bits.

In some examples, the second sequence includes an equal number (e.g., quantity) of ones and zeros.

In some examples, the second sequence includes 10 bits, 12 bits, 14 bits, or 16 bits.

In some examples, a quantity of symbols in the first portion is double a quantity of bits in the second sequence.

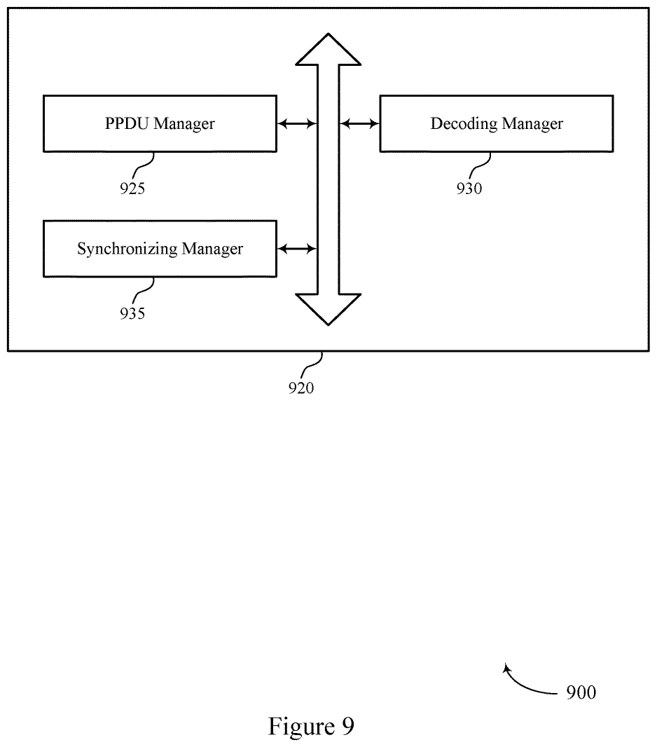

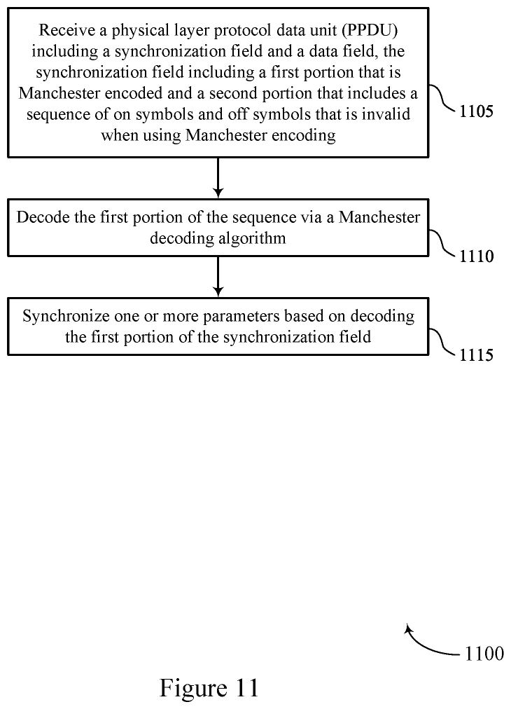

FIG. 9 shows a block diagram 900 of an example wireless communication device 920 that supports ambient power synchronization field design. In some examples, the wireless communication device 920 is configured to perform the process 1100 described with reference to FIG. 11. The wireless communication device 920 may include one or more chips, SoCs, chipsets, packages, components or devices that individually or collectively constitute or include a processing system. The processing system may interface with other components of the wireless communication device 920, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 920 may transmit the information output from the chip. In such an example, the second interface may refer to an interface between the processing system of the chip and a reception component, such that the wireless communication device 920 may receive information that is then passed to the processing system. In some such examples, the first interface also may obtain information, such as from the transmission component, and the second interface also may output information, such as to the reception component.

The processing system of the wireless communication device 920 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 920 may be configurable or configured for use in a STA, such as the STA 104 described with reference to FIG. 1. In some other examples, the wireless communication device 920 may be a STA that includes such a processing system and other components including multiple antennas. The wireless communication device 920 is capable of transmitting and receiving wireless communications in the form of, for example, wireless packets. For example, the wireless communication device 920 may be configurable or configured to transmit and receive packets in the form of physical layer PPDUs and MPDUs conforming to one or more of the IEEE 802.11 family of wireless communication protocol standards. In some other examples, the wireless communication device 920 may be configurable or configured to transmit and receive signals and communications conforming to one or more 3GPP specifications including those for 5G NR or 6G. In some examples, the wireless communication device 920 also includes or may be coupled with one or more application processors which may be further coupled with one or more other memories. In some examples, the wireless communication device 920 further includes a user interface (UI) (such as a touchscreen or keypad) and a display, which may be integrated with the UI to form a touchscreen display that is coupled with the processing system. In some examples, the wireless communication device 920 may further include one or more sensors such as, for example, one or more inertial sensors, accelerometers, temperature sensors, pressure sensors, or altitude sensors, that are coupled with the processing system.

The wireless communication device 920 includes a PPDU manager 925, a decoding manager 930, and a synchronizing manager 935. Portions of one or more of the PPDU manager 925, the decoding manager 930, and the synchronizing manager 935 may be implemented at least in part in hardware or firmware. For example, one or more of the PPDU manager 925, the decoding manager 930, and the synchronizing manager 935 may be implemented at least in part by at least a processor or a modem. In some examples, portions of one or more of the PPDU manager 925, the decoding manager 930, and the synchronizing manager 935 may be implemented at least in part by a processor and software in the form of processor-executable code stored in memory.

The wireless communication device 920 may support wireless communication in accordance with examples as disclosed herein. The PPDU manager 925 is configurable or configured to receive a physical layer protocol data unit (PPDU) including a synchronization field and a data field, the synchronization field including a first portion that is Manchester encoded and a second portion that includes a sequence of on symbols and off symbols that is invalid when using Manchester encoding. The decoding manager 930 is configurable or configured to decode the first portion of the synchronization field via a Manchester decoding algorithm. The synchronizing manager 935 is configurable or configured to synchronize one or more parameters based on decoding the first portion of the synchronization field.

In some examples, the second portion is indicative of an end of the synchronization field.

In some examples, the second portion includes at least three consecutive on symbols or at least three consecutive off symbols.

In some examples, a first symbol of the first portion of the synchronization field includes an off symbol.

In some examples, the first portion of the synchronization field is a Manchester encoded version of a second sequence of bits.

In some examples, the second sequence includes an equal number (e.g., quantity) of ones and zeros.

In some examples, the second sequence includes 10 bits, 12 bits, 14 bits, or 16 bits.

In some examples, a quantity of symbols in the first portion is double a quantity of bits in the second sequence.

FIG. 10 shows a flowchart illustrating an example process 1000 performable by or at an apparatus that supports ambient power synchronization field design. The operations of the process 1000 may be implemented by an apparatus or its components as described herein. For example, the process 1000 may be performed by a wireless communication device, such as the wireless communication device 820 described with reference to FIG. 8, operating as or within a wireless AP. In some examples, the process 1000 may be performed by a wireless AP, such as one of the APs 102 described with reference to FIG. 1.

In some examples, in 1005, the apparatus may generate a physical layer protocol data unit (PPDU) including a synchronization field and a data field, the synchronization field including a first portion that is Manchester encoded and a second portion that includes a sequence of on symbols and off symbols that is invalid when using Manchester encoding. In some implementations, aspects of the operations of 1005 may be performed by a PPDU manager 825 as described with reference to FIG. 8.

In some examples, in 1010, the apparatus may transmit the PPDU. In some implementations, aspects of the operations of 1010 may be performed by a communication manager 830 as described with reference to FIG. 8.

FIG. 11 shows a flowchart illustrating an example process 1100 performable by or at an apparatus that supports ambient power synchronization field design. The operations of the process 1100 may be implemented by an apparatus or its components as described herein. For example, the process 1100 may be performed by a wireless communication device, such as the wireless communication device 920 described with reference to FIG. 9, operating as or within a wireless STA. In some examples, the process 1100 may be performed by a wireless STA, such as one of the STAs 104 described with reference to FIG. 1.

In some examples, in 1105, the apparatus may receive a physical layer protocol data unit (PPDU) including a synchronization field and a data field, the synchronization field including a first portion that is Manchester encoded and a second portion that includes a sequence of on symbols and off symbols that is invalid when using Manchester encoding. In some implementations, aspects of the operations of 1105 may be performed by a PPDU manager 925 as described with reference to FIG. 9.

In some examples, in 1110, the apparatus may decode the first portion of the synchronization field via a Manchester decoding algorithm. In some implementations, aspects of the operations of 1110 may be performed by a decoding manager 930 as described with reference to FIG. 9.

In some examples, in 1115, the apparatus may synchronize one or more parameters based on decoding the first portion of the synchronization field. In some implementations, aspects of the operations of 1115 may be performed by a synchronizing manager 935 as described with reference to FIG. 9.

Implementation examples are described in the following numbered clauses:

The following provides an overview of aspects of the present disclosure:

Clause 1: A method for wireless communication, comprising: generating a PPDU comprising a synchronization field and a data field, the synchronization field comprising a first portion that is Manchester encoded and a second portion that includes a sequence of on symbols and off symbols that is invalid when using Manchester encoding; and transmitting the PPDU.

Clause 2: The method of clause 1, wherein the second portion is indicative of an end of the synchronization field.

Clause 3: The method of clause 2, wherein the second portion comprises at least three consecutive on symbols or at least three consecutive off symbols.

Clause 4: The method of any of clauses 1 through 3, wherein a first symbol of the first portion of the synchronization field comprises an off symbol.

Clause 5: The method of any of clauses 1 through 4, wherein the first portion of the synchronization field is a Manchester encoded version of a second sequence of bits.

Clause 6: The method of clause 5, wherein the second sequence comprises an equal number of ones and zeros.

Clause 7: The method of any of clauses 5 through 6, wherein the second sequence comprises 10 bits, 12 bits, 14 bits, or 16 bits.

Clause 8: The method of any of clauses 5 through 7, wherein a quantity of symbols in the first portion is double a quantity of bits in the second sequence.

Clause 9: A method for wireless communication, comprising: receiving a PPDU comprising a synchronization field and a data field, the synchronization field comprising a first portion that is Manchester encoded and a second portion that includes a sequence of on symbols and off symbols that is invalid when using Manchester encoding; decoding the first portion of the sequence via a Manchester decoding algorithm; and synchronizing one or more parameters based at least in part on decoding the first portion of the synchronization field.

Clause 10: The method of clause 9, wherein the second portion is indicative of an end of the synchronization field.

Clause 11: The method of clause 10, wherein the second portion comprises at least three consecutive on symbols or at least three consecutive off symbols.

Clause 12: The method of any of clauses 9 through 11, wherein a first symbol of the first portion of the synchronization field comprises an off symbol.

Clause 13: The method of any of clauses 9 through 12, wherein the first portion of the synchronization field is a Manchester encoded version of a second sequence of bits.

Clause 14: The method of clause 13, wherein the second sequence comprises an equal number of ones and zeros.

Clause 15: The method of any of clauses 13 through 14, wherein the second sequence comprises 10 bits, 12 bits, 14 bits, or 16 bits.

Clause 16: The method of any of clauses 13 through 15, wherein a quantity of symbols in the first portion is double a quantity of bits in the second sequence.

Clause 17: An apparatus for wireless communication, comprising a processing system that includes processor circuitry and memory circuitry that stores code, the processing system configured to cause the apparatus to perform a method of any of clauses 1 through 8.

Clause 18: An apparatus for wireless communication, comprising at least one means for performing a method of any of clauses 1 through 8.

Clause 19: A non-transitory computer-readable medium storing code for wireless communication, the code comprising instructions executable by one or more processors to perform a method of any of clauses 1 through 8.

Clause 20: An apparatus for wireless communication, comprising a processing system that includes processor circuitry and memory circuitry that stores code, the processing system configured to cause the apparatus to perform a method of any of clauses 9 through 16.

Clause 21: An apparatus for wireless communication, comprising at least one means for performing a method of any of clauses 9 through 16.

Clause 22: A non-transitory computer-readable medium storing code for wireless communication, the code comprising instructions executable by one or more processors to perform a method of any of clauses 9 through 16.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
generate a physical layer protocol data unit (PPDU) comprising a synchronization field and a data field, the synchronization field comprising a first portion that is Manchester encoded and a second portion that includes a sequence of on symbols and off symbols that is invalid when using Manchester encoding; and
transmit the PPDU.

2. The apparatus of claim 1, wherein the second portion is indicative of an end of the synchronization field.

3. The apparatus of claim 2, wherein:
the second portion comprises at least three consecutive on symbols or at least three consecutive off symbols.

4. The apparatus of claim 1, wherein a first symbol of the first portion of the synchronization field comprises an off symbol.

5. The apparatus of claim 1, wherein the first portion of the synchronization field is a Manchester encoded version of a second sequence of bits.

6. The apparatus of claim 5, wherein the second sequence comprises an equal quantity of ones and zeros.

7. The apparatus of claim 5, wherein:
the second sequence comprises 10 bits, 12 bits, 14 bits, or 16 bits.

8. The apparatus of claim 5, wherein a quantity of symbols in the first portion is double a quantity of bits in the second sequence.

9. A wireless station (STA) for wireless communication, comprising:
a processing system that include processor circuitry and memory circuitry that stores code, the processing system configured to cause the STA to:
receive a physical layer protocol data unit (PPDU) comprising a synchronization field and a data field, the synchronization field comprising a first portion that is Manchester encoded and a second portion that includes a sequence of on symbols and off symbols that is invalid when using Manchester encoding;
decode the first portion of the synchronization field via a Manchester decoding algorithm; and
synchronize one or more parameters based at least in part on decoding the first portion of the synchronization field.

10. The STA of claim 9, wherein the second portion is indicative of an end of the synchronization field.

11. The STA of claim 10, wherein:
the second portion comprises at least three consecutive on symbols or at least three consecutive off symbols.

12. The STA of claim 9, wherein a first symbol of the first portion of the synchronization field comprises an off symbol.

13. The STA of claim 9, wherein the first portion of the synchronization field is a Manchester encoded version of a second sequence of bits.

14. The STA of claim 13, wherein the second sequence comprises an equal quantity of ones and zeros.

15. The STA of claim 13, wherein:
the second sequence comprises 10 bits, 12 bits, 14 bits, or 16 bits.

16. The STA of claim 13, wherein a quantity of symbols in the first portion is double a quantity of bits in the second sequence.

17. A method for wireless communication, comprising:
generating a physical layer protocol data unit (PPDU) comprising a synchronization field and a data field, the synchronization field comprising a first portion that is Manchester encoded and a second portion that includes a sequence of on symbols and off symbols that is invalid when using Manchester encoding; and
transmitting the PPDU.

18. The method of claim 17, wherein the second portion is indicative of an end of the synchronization field.

19. The method of claim 18, wherein the second portion comprises at least three consecutive on symbols or at least three consecutive off symbols.

20. The method of claim 17, wherein a first symbol of the first portion of the synchronization field comprises an off symbol.
